(19) United States
(12) Patent Application Publication
(10) Pub. No.: US 2008/0318146 A1
(43) Pub. Date: Dec. 25, 2008

(54) Imaging member having high charge mobility

(75) Inventors: Nancy Belknap, Rochester, NY (US); John F. Yanus, Webster, NY (US); Markus R. Silvestri, Fairport, NY (US); Helen R. Cherniack, Rochester, NY (US); Edward Grabowski, Webster, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Stamford, CT (US)

(21) Appl. No.: 11/820,825

(22) Filed: Jun. 21, 2007

(51) Int. Cl. G03G 15/02

(52) U.S. Cl. 430/58.8; 399/166

(57) ABSTRACT

The presently disclosed embodiments are directed to charge transport layers useful in electrostatography. More particularly, the embodiments pertain to an electrostatographic imaging member comprising a charge transport layer that exhibits improved charge mobility transport and comprises novel terphenyl compounds.

### BACKGROUND

The presently disclosed embodiments relate generally to layers that are useful in imaging apparatus members and components, for use in electrostatographic, including digital, apparatuses. More particularly, the embodiments pertain to an improved electrostatographic imaging member having a charge transport layer comprising a high charge mobility charge transport molecule. The charge transport molecule comprises terphenyl and facilitates improved charge mobility and charge injection in the imaging member.

Electrophotographic imaging members, e.g., photoreceptors, typically include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment move under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. These layers can be in any order, and sometimes can be combined in a single or mixed layer.

Typical multilayered photoreceptors or imaging members have at least two layers, and may include a substrate, a conductive layer, an optional charge blocking layer, an optional adhesive layer, a photogenerating layer (sometimes referred to as a “charge generation layer,” “charge generating layer,” or “charge generator layer”), a charge transport layer, an optional overcoating layer and, in some belt embodiments, an anticurl backing layer. In the multilayer configuration, the active layers of the photoreceptor are the charge generation layer (CGL) and the charge transport layer (CTL). Enhancement of charge transport across these layers provide better photoreceptor performance.

The term “photoreceptor” is generally used interchangeably with the terms “imaging member.” The term “electrostatographic” is generally used interchangeably with the term “electrophotographic.” The terms “charge transport molecule” are generally used interchangeably with the terms “hole transport molecule.” In addition, the terms “charge blocking layer” and “ hole blocking layer” are generally used interchangeably with the phrase “undercoat layer.”

One type of composite photoconductive layer used in xerography is illustrated in U.S. Pat. No. 4,265,990 which describes a photosensitive member having at least two electrically operative layers. One layer comprises a photoconductive layer which is capable of photogenerating holes and injecting the photogenerated holes into a contiguous charge transport layer (CTL). Generally, where the two electrically operative layers are supported on a conductive layer, the photoconductive layer is sandwiched between a contiguous CTL and the supporting conductive layer. Alternatively, the CTL may be sandwiched between the supporting electrode and a photoconductive layer. Photosensitive members having at least two electrically operative layers, as disclosed above, provide excellent electrostatic latent images when charged in the dark with a uniform negative electrostatic charge, exposed to a light image and thereafter developed with finely divided electroscopic marking particles. The resulting toner image is usually transferred to a suitable receiving member such as paper or to an intermediate transfer member which thereafter transfers the image to a member such as paper.

In the case where the charge-generating layer (CGL) is sandwiched between the CTL and the electrically conducting layer, the outer surface of the CTL is charged negatively and the conductive layer is charged positively. The CGL then should be capable of generating electron hole pair when exposed image wise and inject only the holes through the CTL. In the alternate case when the CTL is sandwiched between the CGL and the conductive layer, the outer surface of CGL layer is charged positively while conductive layer is charged negatively and the holes are injected through from the CGL to the CTL. The CTL should be able to transport the holes with as little trapping of charge as possible. In flexible web like photoreceptor the charge conductive layer may be a thin coating of metal on a thin layer of thermoplastic resin.

In a typical machine design, a flexible imaging member belt is mounted over and around a belt support module comprising numbers of belt support rollers, such that the top outermost charge transport layer is exposed to all electrophotographic imaging subsystems interactions. Under a normal machine imaging function condition, the top exposed charge transport layer surface of the flexible imaging member belt is constantly subjected to physical/mechanical/electrical/chemical species actions against the mechanical sliding actions of cleaning blade and cleaning brush, electrical charging devices, corona effluents exposure, developer components, image formation toner particles, hard carrier particles, receiving paper, and the like during dynamic belt cyclic motion. These machine subsystems interaction against the surface of the charge transport layer has been found to consequently cause surface contamination, scratching, abrasion and rapid charge transport layer surface wear problems.

As electrophotography advances, there is a continued need for increasing the speed at which electrophotographic machines can operate. The complex, highly sophisticated duplicating systems need to operate at very high speeds which places stringent requirements including narrow operating limits on photoreceptors. For example, the numerous layers used in many modern photoconductive imaging members must be highly flexible, adhere well to adjacent layers, and exhibit predictable electrical characteristics within narrow operating limits to provide excellent toner images at high speeds over many thousands of cycles.

Current photoreceptors move charge across the layers in roughly the same amount of time as there is between the expose and development stations, for example, approaching a speed of 200 ppm. Thus, it is desirable to increase the speed at which a photoreceptor can discharge in order to gain latitude below 200 ppm or in order to penetrate the 200 ppm level.

### SUMMARY

According to aspects illustrated herein, there is provided an imaging member comprising a substrate in a form of a rigid component, wherein said substrate possesses a thickness of from about 0.5 millimeter to about 10 millimeter, an undercoat layer disposed on the substrate, a charge generation layer disposed on the undercoat layer, a charge transport layer disposed on the charge generation layer, the charge transport layer having a high mobility charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof, and an optional overcoat layer disposed on the charge transport layer.

An embodiment may provide an imaging member comprising a substrate in a form of a rigid component, wherein said substrate possesses a thickness of from about 0.5 millimeter to about 10 millimeters, an undercoat layer disposed on the substrate, a charge transport layer disposed on the undercoat layer, the charge transport layer having a high mobility charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof, a charge generation layer disposed on the charge transport layer, and an optional overcoat layer disposed on the charge generation layer.

Yet another embodiment may provide an imaging member comprising a substrate in a form of a rigid component, wherein said substrate possesses a thickness of from about 0.5 millimeter to about 10 millimeters, an undercoat layer disposed on the substrate, a charge generation layer disposed on the undercoat layer, and a charge transport layer disposed on the charge generation layer, the charge transport layer further comprising a charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof, and a polymeric binder comprising poly(4,4′-dihydroxy-diphenyl-1,1-cyclohexane.

In still another embodiment, there is an image forming apparatus for forming images on a recording medium comprising an imaging member having a charge retentive-surface for receiving an electrostatic latent image thereon, wherein the imaging member comprises a substrate in a form of a rigid component, wherein said substrate possesses a thickness of from about 0.5 millimeter to about 10 millimeters, an undercoat layer disposed on the substrate, a charge generation layer disposed on the undercoat layer, a charge transport layer disposed on the charge generation layer, the charge transport layer having a charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof, and an optional overcoat layer disposed on the charge transport layer, a development component for applying a developer material to the charge-retentive surface to develop the electrostatic latent image to form a developed image on the charge-retentive surface, a transfer component for transferring the developed image from the charge-retentive surface to a copy substrate, and a fusing component for fusing the developed image to the copy substrate.

### BRIEF DESCRIPTION OF THE DRAWINGS

For a better understanding, reference may be had to the accompanying figures.

FIG. 1 is a cross-sectional view of an imaging member according to the present embodiments;

FIG. 2 is a cross-sectional view of an imaging member in a drum configuration according to the present embodiments;

FIG. 3 is a schematic nonstructural view showing an image forming apparatus according to the present embodiments; and

FIG. 4 is a graph showing the flash photo-discharge curves of imaging members configured according to the present embodiments.

### DETAILED DESCRIPTION

In the following description, reference is made to the accompanying drawings, which form a part hereof and which illustrate several embodiments. It is understood that other embodiments may be utilized and structural and operational changes may be made without departure from the scope of the present disclosure.

The presently disclosed embodiments are directed generally to layers useful in imaging apparatus components, such as an imaging member, that exhibit high charge mobility across the layers. In a typical electrostatographic reproducing or digital printing apparatus using a photoreceptor, a light image is recorded in the form of an electrostatic latent image upon a photosensitive member and the latent image is subsequently rendered visible by the application of a developer mixture. The developer, having toner particles contained therein, is brought into contact with the electrostatic latent image to develop the image on an electrostatographic imaging member which has a charge-retentive surface. The developed toner image can then be transferred to a copy substrate, such as paper, that receives the image via a transfer member.

The exemplary embodiments of this disclosure are described below with reference to the drawings. The specific terms are used in the following description for clarity, selected for illustration in the drawings and not to define or limit the scope of the disclosure. The same reference numerals are used to identify the same structure in different figures unless specified otherwise. The structures in the figures are not drawn according to their relative proportions and the drawings should not be interpreted as limiting the disclosure in size, relative size, or location. In addition, though the discussion will address negatively charged systems, the imaging members of the present disclosure may also be used in positively charged systems.

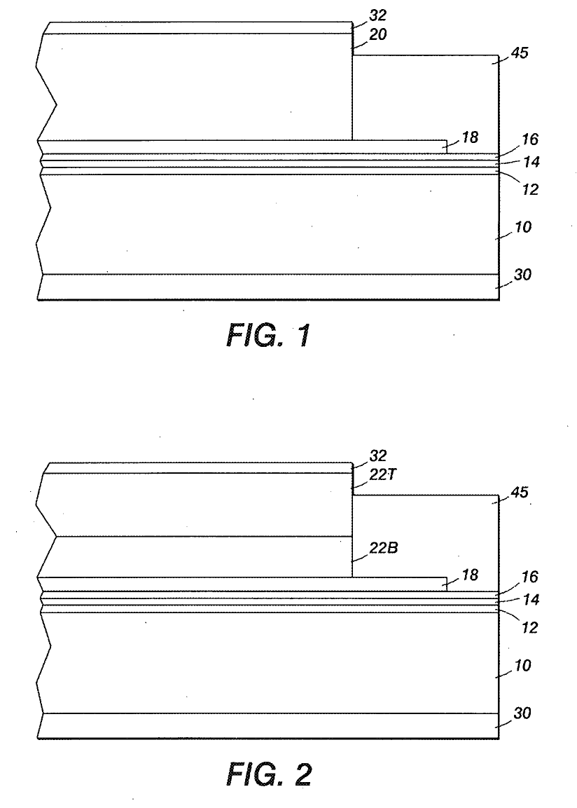

An exemplary embodiment of a multilayered electrophotographic imaging member is illustrated in FIG. 1. The exemplary imaging member includes a rigid support substrate 10 having an optional conductive surface layer or layers 12 (which may be referred to herein as a ground plane layer), optional if the substrate itself is conductive, a hole blocking layer 14, an optional adhesive interface layer 16, a charge generation layer 18 and a charge transport layer 20. The charge generation layer 18 and the charge transport layer 20 forms an imaging layer described here as two separate layers. In an alternative to what is shown in the figure, the charge generation layer may also be disposed on top of the charge transport layer. It will be appreciated that the functional components of these layers may alternatively be combined into a single layer. As an alternative to a single charge transport layer 20, as shown in FIG. 1, the charge transport layer may also comprise multiple layers, with the other layers of the imaging member being formed in the same manner as in FIG. 1.

Other layers of the imaging member may include, for example, an optional over coat layer 32. An optional overcoat layer 32, if desired, may be disposed over the charge transport layer 20 to provide imaging member surface protection as well as improve resistance to abrasion. An anti-curl backing layer 30 of the photoreceptor may, in flexible web configurations, be formed on the backside of the support substrate 10. The conductive ground plane 12 is typically a thin metallic layer, for example a 10 nanometer thick titanium coating, deposited over the substrate 10 by vacuum deposition or sputtering process. The layers 14, 16, 18, and 20 may be separately and sequentially deposited on to the surface of conductive ground plane 12 of substrate 10 as solutions comprising a solvent, with each layer being dried before deposition of the next.

Although the coatings disclosed herein are applicable to electrophotographic imaging members in either flexible belt configuration or rigid drum form, for reason of simplicity, the discussions below are focused upon electrophotographic imaging members in drum form, as generally disclosed, for example, in U.S. Pat. Nos. 5,415,961 and 5,550,618. The long term durability of drum-type photoreceptors greatly exceeds that of belt-type photoreceptors. Some drum photoreceptors are coated with one or more coatings. Coatings may be applied by well known techniques such as dip coating or spray coating. Dip coating of drums usually involves immersing of a cylindrical drum while the axis of the drum is maintained in a vertical alignment during the entire coating and subsequent drying operation.

FIG. 2 is an exemplary embodiment of a multilayered electrophotographic imaging member having a drum configuration. As can be seen, the exemplary imaging member includes a rigid support substrate 10, an undercoat layer 12, a charge generation layer 18 and a charge transport layer 20. The rigid substrate may be comprised of a material selected from the group consisting of a metal, metal alloy, aluminum, zirconium, niobium, tantalum, vanadium, hafnium, titanium, nickel, stainless steel, chromium, tungsten, molybdenum, and mixtures thereof. The charge generation layer 18 and the charge transport layer 20 forms an imaging layer described here as two separate layers. In an alternative to what is shown in the figure, the charge generation layer may also be disposed on top of the charge transport layer. It will be appreciated that the functional components of these layers may alternatively be combined into a single layer.

Other layers of the imaging member may include, for example, an optional over coat layer 32. An optional overcoat layer 32, if desired, may be disposed over the charge transport layer 20 to provide imaging member surface protection as well as improve resistance to abrasion. In embodiments, the overcoat layer 32 may have a thickness ranging from about 0.1 micrometers to about 10 micrometers or from about 1 micrometers to about 10 micrometers. These overcoating layers are well known in the art and may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene, and combinations thereof. Suitable resins include those described above as suitable for photogenerating layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoatings may be continuous and have a thickness from about 0.5 micrometers to about 10 micrometers, in embodiments from about 2 micrometers to about 6 micrometers.

The Substrate

The photoreceptor support substrate 10 may be opaque or substantially transparent, and may comprise any suitable organic or inorganic material having the requisite mechanical properties. The entire substrate can comprise the same material as that in the electrically conductive surface, or the electrically conductive surface can be merely a coating on the substrate. Any suitable electrically conductive material can be employed. Typical electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be single metallic compound or dual layers of different metals and/or oxides.

The substrate 10 can also be formulated entirely of an electrically conductive material, or it can be an insulating material including-inorganic or organic polymeric materials, such as MYLAR, a commercially available biaxially oriented polyethylene terephthalate from DuPont, or polyethylene naphthalate available as KALEDEX 2000, with a ground plane layer 12 comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support substrate depends on numerous factors, including mechanical performance and economic considerations.

The substrate 10 may have a number of many different configurations, such as for example, a plate, a cylinder, a drum, a scroll, an endless flexible belt, and the like. In the case of the substrate being in the form of a belt, the belt can be seamed or seamless.

The thickness of the substrate 10 depends on numerous factors, including flexibility, mechanical performance, and economic considerations. The thickness of the support substrate 10 may range from about 25 micrometers to about 3,000 micrometers. For rigid drum substrates, the thickness ranges from about 0.5 millimeter to about 10 millimeters. In embodiments of photoreceptor preparation, the thickness of substrate 10 is from about 50 micrometers to about 200 micrometers for optimum flexibility and to effect minimum induced photoreceptor surface bending stress when a photoreceptor belt is cycled around small diameter rollers in a machine belt support module, for example, 19 millimeter diameter rollers.

An exemplary substrate support 10 is not soluble in any of the solvents used in each coating layer solution, is optically transparent or semi-transparent, and is thermally stable up to a high temperature of about 150° C. A typical substrate support 10 used for imaging member fabrication has a thermal contraction coefficient ranging from about 1×10⁻⁵ per ° C. to about 3×10⁻⁵ per ° C. and a Young's Modulus of between about 5×10⁻⁵ psi (3.5×10⁻⁴ Kg/cm²) and about 7×10⁻⁵ psi (4.9×10⁻⁴ Kg/cm²).

The Conductive Layer

The conductive ground plane layer 12 may vary in thickness depending on the optical transparency and flexibility desired for the electrophotographic imaging member. When a photoreceptor flexible belt is desired, the thickness of the conductive layer 12 on the support substrate 10, for example, a titanium and/or zirconium conductive layer produced by a sputtered deposition process, typically ranges from about 2 nanometers to about 75 nanometers to allow adequate light transmission for proper back erase, and in embodiments from about 10 nanometers to about 20 nanometers for an optimum combination of electrical conductivity, flexibility, and light transmission. Generally, for rear erase exposure, a conductive layer light transparency of at least about 15 percent is desirable. The conductive layer need not be limited to metals. The conductive layer 12 may be an electrically conductive metal layer which may be formed, for example, on the substrate by any suitable coating technique, such as a vacuum depositing or sputtering technique. Typical metals suitable for use as conductive layer 12 include aluminum, zirconium, niobium, tantalum, vanadium, hafnium, titanium, nickel, stainless steel, chromium, tungsten, molybdenum, combinations thereof, and the like. Where the entire substrate is an electrically conductive metal, the outer surface can perform the function of an electrically conductive layer and a separate electrical conductive layer may be omitted. Other examples of conductive layers may be combinations of materials such as conductive indium tin oxide as a transparent layer for light having a wavelength between about 4000 Angstroms and about 9000 Angstroms or a conductive carbon black dispersed in a plastic binder as an opaque conductive layer.

The illustrated embodiment will be described in terms of a substrate layer 10 comprising an insulating material including inorganic or organic polymeric materials, such as, MYLAR with a ground plane layer 12 comprising an electrically conductive material, such as titanium or titanium/zirconium, coating over the substrate layer 10.

The Hole Blocking Layer

An optional hole blocking layer 14 may then be applied to the substrate 10 or to the layer 12, where present. Any suitable positive charge (hole) blocking layer capable of forming an effective barrier to the injection of holes from the adjacent conductive layer 12 into the photoconductive or charge generation layer may be utilized. In a specific embodiment, the undercoat layer comprises a compound selected from the group consisting of phenolic resin, phenolic compound, metal oxide, silicon oxide and mixtures thereof. The metal oxides include, for example, titanium oxide, zirconium oxide, magnesium oxide, calcium oxide, beryllium oxide lanthanum oxide, and the like. Other compounds further include polyamides, hydroxy alkyl methacrylates, nylons, gelatin, hydroxyl alkyl cellulose, organopolyphosphazines, organosilanes, organotitanates, organozirconates, nitrogen-containing siloxanes, and mixtures thereof. The charge (hole) blocking layer may include polymers, such as, polyvinylbutyral, epoxy resins, polyesters, polysiloxanes, polyamides, polyurethanes, HEMA, hydroxylpropyl cellulose, polyphosphazine, and the like, or may comprise nitrogen containing siloxanes or silanes, or nitrogen containing titanium or zirconium compounds, such as, titanate and zirconate. The hole blocking layer should be continuous and may have a thickness in a wide range of from about 0.2 micrometers to about 25 micrometers depending on the type of material chosen for use in a photoreceptor design. Typical hole blocking layer materials include, for example, trimethoxysilyl propylene diamine, hydrolyzed trimethoxysilyl propyl ethylene diamine, N-beta-(aminoethyl)gamma-aminopropyl trimethoxy silane, isopropyl 4-aminobenzene sulfonyl di(dodecylbenzene sulfonyl)titanate, isopropyl di(4-aminobenzoyl)isostearoyl titanate, isopropyl tri(N-ethylaminoethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, (gamma-aminobutyl)methyl diethoxysilane which has the formula [H₂N(CH₂)₄]CH₃Si(OCH₃)₂, and (gamma-aminopropyl)methyl diethoxysilane, which has the formula [H₂N(CH₂)₃]CH₃₃Si(OCH₃)₂, and combinations thereof, as disclosed, for example, in U.S. Pat. Nos. 4,338,387; 4,286,033; and 4,291,110, incorporated herein by reference in their entireties. An embodiment of a hole blocking layer comprises a reaction product between a hydrolyzed silane or mixture of hydrolyzed silanes and the oxidized surface of a metal ground plane layer. The oxidized surface inherently forms on the outer surface of most metal ground plane layers when exposed to air after deposition. This combination enhances electrical stability at low RH. Other suitable charge blocking layer polymer compositions are also described in U.S. Pat. No. 5,244,762 which is incorporated herein by reference in its entirety. These include vinyl hydroxyl ester and vinyl hydroxy amide polymers wherein the hydroxyl groups have been partially modified to benzoate and acetate esters which are then blended with other unmodified vinyl hydroxy ester and amide unmodified polymers. An example of such a blend is a 30 mole percent benzoate ester of poly (2-hydroxyethyl methacrylate) blended with the parent polymer poly (2-hydroxyethyl methacrylate). Still other suitable charge blocking layer polymer compositions are described in U.S. Pat. No. 4,988,597, which is incorporated herein by reference in its entirety. These include polymers containing an alkyl acrylamidoglycolate alkyl ether repeat unit. An example of such an alkyl acrylamidoglycolate alkyl ether containing polymer is the copolymer poly(methyl acrylamidoglycolate methyl ether-co-2-hydroxyethyl methacrylate).

The blocking layer 14 can be continuous or substantially continuous and may have a thickness of less than about 10 micrometers because greater thicknesses may lead to undesirably high residual voltage. In aspects of the exemplary embodiment, a blocking layer of from about 0.005 micrometers to about 2 micrometers gives optimum electrical performance. The blocking layer may be applied by any suitable conventional technique, such as, spraying, dip coating, draw bar coating, gravure coating, silk screening, air knife coating, reverse roll coating, vacuum deposition, chemical treatment, and the like. For convenience in obtaining thin layers, the blocking layer may be applied in the form of a dilute solution, with the solvent being removed after deposition of the coating by conventional techniques, such as, by vacuum, heating, and the like. Generally, a weight ratio of blocking layer material and solvent of between about 0.05:100 to about 5:100 is satisfactory for spray coating.

The Adhesive Interface Layer

An optional separate adhesive interface layer 16 may be provided in certain configurations, such as for example, in flexible web configurations. In the embodiment illustrated in FIG. 1, an interface layer 16 is situated intermediate the blocking layer 14 and the charge generator layer 18. The interface layer may include a copolyester resin. Exemplary polyester resins which may be utilized for the interface layer include polyarylatepolyvinylbutyrals, such as ARDEL POLYARYLATE (U-100) commercially available from Toyota Hsutsu Inc., VITEL PE-100, VITEL PE-200, VITEL PE-200D, and VITEL PE-222, all from Bostik, 49,000 polyester from Rohm Hass, polyvinyl butyral, and the like. The adhesive interface layer 16 may be applied directly to the hole blocking layer 14. Thus, the adhesive interface layer 16 in embodiments is in direct contiguous contact with both the underlying hole blocking layer 14 and the overlying charge generator layer 18 to enhance adhesion bonding to provide linkage. In yet other embodiments, the adhesive interface layer 16 is entirely omitted.

Any suitable solvent or solvent mixtures may be employed to form a coating solution of the polyester for the adhesive interface layer 16. Typical solvents include tetrahydrofuran, toluene, monochlorbenzene, methylene chloride, cyclohexanone, and the like, and mixtures thereof. Any other suitable and conventional technique may be used to mix and thereafter apply the adhesive layer coating mixture to the hole blocking layer. Typical application techniques include spraying, dip coating, roll coating, wire wound rod coating, and the like. Drying of the deposited wet coating may be effected by any suitable conventional process, such as oven drying, infra red radiation drying, air drying, and the like.

The adhesive interface layer 16 may have a thickness of from about 0.01 micrometers to about 900 micrometers after drying. In embodiments, the dried thickness is from about 0.03 micrometers to about 1 micrometer.

The Charge Generation Layer

The charge generation layer 18 may thereafter be applied to the adhesive layer 16. Any suitable charge generation binder including a charge generating/photoconductive material, which may be in the form of particles and dispersed in a film forming binder, such as an inactive resin, may be utilized. Examples of charge generating materials include, for example, inorganic photoconductive materials such as amorphous selenium, trigonal selenium, and selenium alloys selected from the group consisting of selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions may be utilized where a photoconductive layer enhances or reduces the properties of the charge generation layer. Other suitable charge generating materials known in the art may also be utilized, if desired. The charge generating materials selected should be sensitive to activating radiation having a wavelength between about 400 and about 900 nm during the imagewise radiation exposure step in an electrophotographic imaging process to form an electrostatic latent image. For example, hydroxygallium phthalocyanine absorbs light of a wavelength of from about 370 to about 950 nanometers, as disclosed, for example, in U.S. Pat. No. 5,756,245.

Any suitable inactive resin materials may be employed as a binder in the charge generation layer 18, including those described, for example, in U.S. Pat. No. 3,121,006, the entire disclosure thereof being incorporated herein by reference. Typical organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

The charge generating material can be present in the resinous binder composition in various amounts. Generally, from about 5 percent by volume to about 90 percent by volume of the charge generating material is dispersed in about 10 percent by volume to about 95 percent by volume of the resinous binder, and more specifically from about 20 percent by volume to about 60 percent by volume of the charge generating material is dispersed in about 40 percent by volume to about 80 percent by volume of the resinous binder composition.

The charge generation layer 18 may have a thickness ranging from about 0.01 micrometer to about 5 micrometers. The charge generation layer 18 containing the charge generating material and the resinous binder material generally ranges in thickness of from about 0.1 micrometer to about 5 micrometers, for example, from about 0.2 micrometer to about 3 micrometers when dry. The charge generation layer thickness is generally related to binder content. Higher binder content compositions generally employ thicker layers for charge generation.

The Charge Transport Layer

In a drum photoreceptor, the charge transport layer comprises a single layer of the same composition. As such, the charge transport layer will be discussed specifically in terms of a single layer 20, but the details will be also applicable to an embodiment having dual charge transport layers 22T and 22B. The charge transport layer 20 is thereafter applied over the charge generation layer 18 and may include any suitable transparent organic polymer or non-polymeric material capable of supporting the injection of photogenerated holes or electrons from the charge generation layer 18 and capable of allowing the transport of these holes/electrons through the charge transport layer to selectively discharge the surface charge on the imaging member surface. In one embodiment, the charge transport layer 20 not only serves to transport holes, but also protects the charge generation layer 18 from abrasion or chemical attack and may therefore extend the service life of the imaging member. The charge transport layer 20 can be a substantially non-photoconductive material, but one which supports the injection of photogenerated holes from the charge generation layer 18.

The layer 20 is normally transparent in a wavelength region in which the electrophotographic imaging member is to be used when exposure is effected therethrough to ensure that most of the incident radiation is utilized by the underlying charge generation layer 18. The charge transport layer should exhibit excellent optical transparency with negligible light absorption and no charge generation when exposed to a wavelength of light useful in xerography, e.g., 400 to 900 nanometers. In the case when the photoreceptor is prepared with the use of a transparent substrate 10 and also a transparent or partially transparent conductive layer 12, image wise exposure or erase may be accomplished through the substrate 10 with all light passing through the back side of the substrate. In this case, the materials of the layer 20 need not transmit light in the wavelength region of use if the charge generation layer 18 is sandwiched between the substrate and the charge transport layer 20. The charge transport layer 20 in conjunction with the charge generation layer 18 is an insulator to the extent that an electrostatic charge placed on the charge transport layer is not conducted in the absence of illumination. The charge transport layer 20 should trap minimal charges as the charge passes through it during the discharging process.

The charge transport layer 20 may include any suitable charge transport component or activating compound useful as an additive dissolved or molecularly dispersed in an electrically inactive polymeric material, such as a polycarbonate, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes through. This addition converts the electrically inactive polymeric material to a material capable of supporting the injection of photogenerated holes from the charge generation layer 18 and capable of allowing the transport of these holes through the charge transport layer 20 in order to discharge the surface charge on the charge transport layer. The charge transport component typically comprises small molecules of an organic compound which cooperate to transport charge between molecules and ultimately to the surface of the charge transport layer.

Examples of the binder materials selected for the charge transport layers include components, such as those described in U.S. Pat. No. 3,121,006, the disclosure of which is totally incorporated herein by reference. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments electrically inactive binders are comprised of polycarbonate resins with for example a molecular weight of from about 20,000 to about 150,000 and more specifically with a molecular weight M_{w} of from about 50,000 to about 100,000. Examples of polycarbonates are poly(4,4′-isopropylidene-diphenylene)carbonate (also referred to as bisphenol-A-polycarbonate, poly(4,4′-cyclohexylidinediphenylene)carbonate (referred to as bisphenol-Z polycarbonate), poly(4,4′-isopropylidene-3,3′-dimethyl-diphenyl)carbonate (also referred to as bisphenol-C-polycarbonate) and the like. In embodiments, the charge transport layer, such as a hole transport layer, may have a thickness from about 10 to about 55 microns.

As discussed previously, there is a need to increase the speed at which current imaging members are able to operate. The current mobility composites described above, while suitable for their intended purposes, do not provide the desired charge mobility speed. The key measurement of speed of a imaging member's ability to move charge is its hole mobility, which is expressed either as a function of applied filed or as a mobility at a certain field.

The charge transport layers of the present embodiments comprise specific high mobility charge transport molecules comprising terphenyl compounds. The terphenyl compounds may be selected from the following: N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof. Imaging members produced using the above charge transport molecules allow charges to leave the photosensitive pigment particles and move out of the charge generation layer efficiently. For example, an imaging member having the terphenyl compounds exhibits charge injection from the charge generation layer into the charge transport layer at less than 50 milliseconds. The efficient charge injection and transport of charge out of the charge generation layer results in less residual charge in the generation layer that can give rise to print defects like ghosting. Another advantage of the present embodiments is very small CTM concentration dependence (e.g., very low residual voltages at high or low CTM loadings). As such, imaging members comprising these high mobility charge transport molecules have reduced ghosting levels due to very low residual charges in the imaging member after discharge.

In embodiments, the charge transport layer includes a high mobility charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-Ni,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof. The terphenyl compound may be present in the charge transport layer in an amount of about 25 percent to about 40 percent by weight of total weight of the charge transport layer. In further embodiments, the terphenyl compound may be present in the charge transport layer in an amount of from about 20 percent to about 50 percent by weight of total weight of the charge transport layer, or from about 25 percent to about 45 percent by weight of total weight of the charge transport layer. In further embodiments, the charge transport layer includes a top and bottom layer, with the top and bottom layer being in contact with the charge generation layer. In these embodiments, the compound can be present in the charge transport layer in the same ratios as is present in the embodiment with the single charge transport layer.

The charge transport layer may further include a polymeric binder having a viscosity-molecular weight of from about 20,000 to about 150,000. For example, in embodiments, the polymeric binder may be a polycarbonate Z polymer. In a specific embodiment, the polymeric binder is poly(4,4′-dihydroxy-diphenyl-1,1-cyclohexane. The polymeric binder may be present in the charge transport layer in an amount of about 40 percent to about 80 percent, or about 50 percent to about 80 percent, by weight of total weight of the charge transport layer. In embodiments, a ratio of the charge transport molecule to the polymeric binder present in the charge transport layer is from about 20:80 to about 40:60, or from about 25:75 to about 50:50. In further embodiments, the charge transport layer may also comprise polytetrafluoroethylene (PTFE) particles uniformly dispersed throughout the polymeric binder to stabilize the layer and extend the life of the imaging member. The embodiments do, however, also cover imaging members where particle additives are not added to the charge transport layer.

The thickness of the charge transport layer is, in embodiments, from about 2 μm to about 65 μm, from about 5 μm to about 60 μm, or more specifically, from about 5 μm to about 55 μm. In a specific embodiment, the charge generation layer comprises hydroxygallium phthalocyanine type V pigment when one of the terphenyl compounds are used as the high mobility charge transport molecule. In further embodiments, the charge generator or pigment may be metal phthalocyanine, metal free phthalocyanine, perylene, hydroxygallium phthalocyanine, chlorogallium phthalocyanine, methoxygallium phthalocyanine, vanadyl phthalocyanine, selenium, selenium alloy, trigonal selenium, and the like, and mixtures thereof.

Examples of components or materials optionally incorporated into the charge transport layers or at least one charge transport layer to, for example, enable improved lateral charge migration (LCM) resistance include hindered phenolic antioxidants such as tetrakis methylene(3,5-di-tert-butyl-4-hydroxy hydrocinnamate) methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd.), TINUVIN® 144 and 622LD (available from Ciba Specialties Chemicals), MARK™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd); phosphite antioxidants such as MARK™2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layer is from about 0 to about 20, from about 1 to about 10, or from about 3 to about 8 weight percent.

The charge transport layer should be an insulator to the extent that the electrostatic charge placed on the hole transport layer is not conducted in the absence of illumination at a rate sufficient to prevent formation and retention of an electrostatic latent image thereon. In general, the thickness of the charge transport layer can be maintained from about 2 μm to about 65 μm, or more specifically, from about 5 μm to about 55 μm. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used.

Drying of the deposited coating may be effected by any suitable conventional technique such as oven drying, infra red radiation drying, air drying and the like. The thickness of the charge transport layer after drying is from about 10 micrometers to about 40 micrometers or from about 24 micrometers to about 34 micrometers for optimum photoelectrical and mechanical results.

For electrographic imaging members, a flexible dielectric layer overlying the conductive layer may be substituted for the active photoconductive layers. Any suitable, conventional, flexible, electrically insulating, thermoplastic dielectric polymer matrix material may be used in the dielectric layer of the electrographic imaging member. If desired, the flexible belts disclosed herein may be used for other purposes where cycling durability is important.

The prepared imaging drum may thereafter be employed in any suitable and conventional electrophotographic imaging process which utilizes uniform charging prior to imagewise exposure to activating electromagnetic radiation. When the imaging surface of an electrophotographic member is uniformly charged with an electrostatic charge and imagewise exposed to activating electromagnetic radiation, conventional positive or reversal development techniques may be employed to form a marking material image on the imaging surface of the electrophotographic imaging member. Thus, by applying a suitable electrical bias and selecting toner having the appropriate polarity of electrical charge, a toner image is formed in the charged areas or discharged areas on the imaging surface of the electrophotographic imaging member. For example, for positive development, charged toner particles are attracted to the oppositely charged electrostatic areas of the imaging surface and for reversal development, charged toner particles are attracted to the discharged areas of the imaging surface.

The electrophotographic device can be evaluated by printing in a marking engine into which a photoreceptor belt formed according to the exemplary embodiment has been installed. For intrinsic electrical properties it can also be investigated by conventional electrical drum scanners.

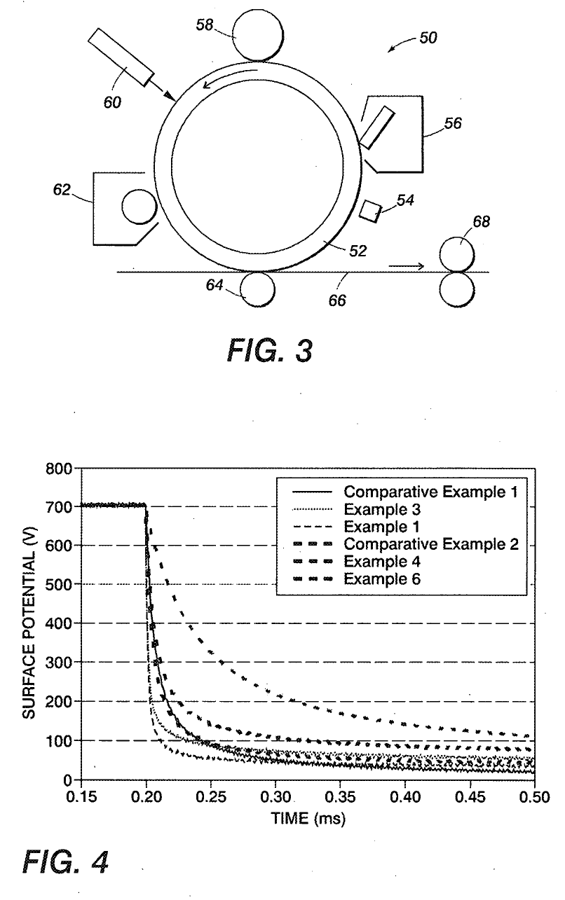

FIG. 3 shows a schematic constitution of an embodiment of an image forming apparatus 50. The image forming apparatus 50 is equipped with an imaging member 52, such as a cylindrical imaging or photoreceptor drum, having a charge retentive surface to receive an electrostatic latent image thereon. Around the imaging member 52 may be disposed a static eliminating light source 54 for eliminating residual electrostatic charges on the imaging member 52, an optional cleaning blade 56 for removing the toner remained on the imaging member 52, a charging component 58, such as a charger roll, for charging the imaging member 52, a light-exposure laser optical system 60 for exposing the imaging member 52 based on an image signal, a development component 62 to apply developer material to the charge-retentive surface to create a developed image in the imaging member 52, and a transfer component 64, such as a transfer roll, to transferring a toner image from the imaging member 52 onto a copy substrate 66, such as paper, in this order. Also, the image forming apparatus 50 is equipped with a fusing component 68, such as a fuser/fixing roll, to fuse the toner image transferred onto the copy substrate 66 from the transfer component 64.

The light exposure laser optical system 60 is equipped with a laser diode (for example, oscillation wavelength 780 nm) for irradiating a laser light based on an image signal subjected to a digital treatment, a polygon mirror polarizing the irradiated laser light, and a lens system of moving the laser light at a uniform velocity with a definite size.

Various exemplary embodiments encompassed herein include a method of imaging which includes generating an electrostatic latent image on an imaging member, developing a latent image, and transferring the developed electrostatic image to a suitable substrate.

In a selected embodiment, an image forming apparatus for forming images on a recording medium comprising: a) an imaging member having a charge retentive-surface for receiving an electrostatic latent image thereon, wherein the imaging member comprises a substrate, a charge generating layer disposed on the substrate, and at least one charge transport layer disposed on the charge generating layer, the at least one charge transport layer having a charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof; b) a development component for applying a developer material to the charge-retentive surface to develop the electrostatic latent image to form a developed image on the charge-retentive surface; c) a transfer component for transferring the developed image from the charge-retentive surface to a copy substrate; and d) a fusing component for fusing the developed image to the copy substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Example 1

A charge transport layer solution comprises N,N′-bis(4-methylphenyl)-N,N′-bis[4-(n-butyl)phenyl]-[p-terphenyl]-4,4″-diamine (p-MeTer) (3.85 grams), a polycarbonate PCZ-400 (poly(4,4′-dihydroxy-diphenyl-1-1-cyclohexane), M_{w}=40,000) available from Mitsubishi Gas Chemical Company, Ltd. (7.15 grams), 29.25 grams of tetrahydrofuran, and 9.75 grams of toluene. The solution is mixed, then applied directly over the charge generating layer of the photoreceptor drum. The charge transport layer is applied by a ring coating method and dried in a forced air oven at 135° C. for 40 minutes with the resulting dried layer having a thickness of about 30 micrometers. The resulting charge transport layer comprises 35% of the hole transport molecule p-MeTer.

### Example 2

A photoreceptor drum is prepared according to Example 1, except the charge transport layer solution comprises N,N′-bis(4-methylphenyl)-N,N′-bis[4-(n-butyl)phenyl]-[p-terphenyl]-4,4″-diamine (p-MeTer) (2.46 grams), PCZ-400 (7.36 grams), 30.14 grams of tetrahydrofuran, and 10.05 grams of toluene. The resulting charge transport layer comprises 25% of the hole transport molecule p-MeTer.

### Example 3

A photoreceptor drum is prepared according to Example 1, except the charge transport layer solution comprises N,N′-bis(3-methylphenyl)-N,N′-bis[4-(n-butyl)phenyl]-[p-terphenyl]-4,4″-diamine (m-MeTer) (3.85 grams), PCZ-400 (7.15 grams), 29.25 grams of tetrahydrofuran, and 9.75 grams of toluene. The resulting charge transport layer comprises 35% of the hole transport molecule m-MeTer.

### Example 4

A photoreceptor drum is prepared according to Example 1, except the charge transport layer solution comprises N,N′-bis(3-methylphenyl)-N,N′-bis[4-(n-butyl)phenyl]-[p-terphenyl]-4,4″-diamine (m-MeTer) (2.46 grams), PCZ-400 (7.36 grams), 30.14 grams of tetrahydrofuran, and 10.05 grams of toluene. The resulting charge transport layer comprises 25% of the hole transport molecule m-MeTer.

### Example 5

A photoreceptor drum is prepared according to Example 1, except the charge transport layer solution comprises N,N′-bis(4-tert-butylphenyl)-N,N′-bis[4-(n-butyl)phenyl]-[p-terphenyl]-4,4″-diamine (4-tBuTer) (3.85 grams), PCZ-400 (7.15 grams), 29.25 grams of tetrahydrofuran, and 9.75 grams of toluene. The resulting charge transport layer comprises 35% of the hole transport molecule 4-tBuTer.

### Example 6

A photoreceptor drum is prepared according to Example 1, except the charge transport layer solution comprises N,N′-bis(4-tert-butylphenyl)-N,N′-bis[4-(n-butyl)phenyl]-[p-terphenyl]-4,4″-diamine (4-tBuTer) (2.46 grams), PCZ-400 (7.36 grams), 30.14 grams of tetrahydrofuran, and 10.05 grams of toluene. The resulting charge transport layer comprises 25% of the hole transport molecule 4-tBuTer.

### Comparative Example 1

A photoreceptor drum is prepared according to Example 1, except the charge transport layer solution comprises TPD (3.85 grams), PCZ-400 (7.15 grams), 29.25 grams of tetrahydrofuran, and 9.75 grams of toluene. The resulting charge transport layer comprises 35% of the hole transport molecule TPD.

### Comparative Example 2

A photoreceptor drum is prepared according to Example 1, except the charge transport layer solution comprises TPD (2.46 grams), PCZ-400 (7.36 grams), 30.14 grams of tetrahydrofuran, and 10.05 grams of toluene. The resulting charge transport layer comprises 25% of the hole transport molecule TPD.

The resulting photoreceptor devices were electrically tested with a cyclic scanner set to obtain 100 charge-erase cycles immediately followed by an additional 100 cycles, sequenced at 2 charge-erase cycles and 1 charge-expose-erase cycle, wherein the light intensity was incrementally increased with cycling to produce a photoinduced discharge curve from which the photosensitivity was measured. The scanner was equipped with a pin scorotron (5 centimeters wide) set to control the applied potential at −700 volts on the surface of the drum devices.

The devices were tested in the negative charging mode. The exposure light intensity was incrementally increased by means of regulating a series of neutral density filters. The exposure source was an LED cluster with wavelength at 770±15 nanometers.

The drum was rotated at a speed of 70 rpm to produce a surface speed of 110 millimeters/second or a cycle time of 0.86 seconds. The xerographic simulation was carried out in an environmentally controlled light tight chamber at the following conditions; A) 80 percent relative humidity and 28° C. or B) 20 percent relative humidity and 10° C. The results of these tests under condition A are set forth below in Table 1, where Vᵣ and V_{low} are the residual voltage measured after 100 erg erase at 660 nm and the residual voltages after a given amount of light exposure, respectively; V_{depl}, represents the leakage voltage, or the inability of the device to hold a small amount of applied charge.

In Table 1, the dark decay of the photoreceptor was measured by monitoring the surface potential after applying a single charge cycle of 50 nanocoulombs/cm² while maintaining the photoreceptor in dark (without light exposure). The voltage of the device (V_{low}) was measured at exposure levels of 2.8 erg/cm² to record the residual voltage obtained after the device is partially exposed and at 13 erg/cm² to record the residual voltage obtained when the device is fully exposed. The charge capacity was measured by applying increasing amounts of charge from about 2 to about 120 nC/cm², and monitoring the resulting voltage (with erase) to generate a charge-voltage curve. The low field voltage depletion was calculated from a linear regression of the charge-voltage curve, with the V_{depl} voltage represented by the intercept at zero applied charge.

TABLE 1

| Example | Vdep (V) | Vlow (V) | Vr (V) | Dark Decay (V/s) |
|---|---|---|---|---|
| Comparative | 66.45 | 216.33 | 160.12 | 21.39 |
| Example II | | | | |
| Example II | 47.33 | 128.95 | 55.52 | 9.31 |
| Example IV | 43.93 | 175.71 | 98.95 | 12.55 |
| Example VI | 64.72 | 173.14 | 93.76 | 11.76 |

From the data above, all samples resulted in desired photoreceptor behavior, even at the less than optimal loading of 25 wt %. The lower residual voltage, low field depletion and dark decay rates obtained for devices of Examples II, IV & VI indicate less trapped charge and residual dark current leakage than the Comparative Example II. These results indicate more efficient movement of charge out of the CGL despite the low concentration of transport molecule in the CTL. Even at very low molecular doping levels, these high mobility materials enable efficient movement of holes through the charge transport layer and are expected to facilitate better charge separation at the generator-transport layer interface.

The results of testing under condition A and B are set forth below in Table 2, where the response to environmental change is quantified by the difference in residual voltage and dark decay.

TABLE 2

| Example | CG | Delta Vr | Delta DD |
|---|---|---|---|
| Comparative Example I | CIGaPc | 89.25 | 5.39 |
| Example III | CIGaPc | 59.43 | 2.36 |
| Example V | CIGaPc | 101.38 | 5.05 |
| Example I | CIGaPc | 40.51 | 1.66 |
| Comparative Example I | OHGaPc | 84.14 | 5.09 |
| Example III | OHGaPc | 54.37 | 4.00 |
| Example V | OHGaPc | 104.57 | 5.64 |
| Example I | OHGaPc | 26.24 | 1.29 |

The devices in Table 2 were constructed with both chlorogallium (ClGaPc) and hydroxygallium (OHGaPc) charge generation layers as indicated in the CG column. As seen in Table 2, the response to environmental change is greatly reduced by the devices of Examples I and III, indicating more stable photoreceptor performance under varied environmental conditions. Frequently the environmental conditions within a printer can change with job run length and the photoreceptor may be exposed to different conditions based on subsystem impacts (i.e. fusing). The devices of this invention are shown to be more robust with respect to these localized environments and may not require any special acclimatization efforts to insure performance.

The resulting photoreceptor devices were electrically tested with a flash photo-discharge scanner set to obtain time resolved photo-discharge curves. The scanner was equipped with a pin scorotron (5 centimeters wide) set to control the applied potential at −720 volts on the surface of the drum devices. The devices were allowed to decay in the absence of light until reaching the threshold voltage of −700V. A white light flash exposure set to fully discharge the device was enabled and the resulting discharge was monitored by an electrostatic voltage probe.

The results of the testing are shown in FIG. 4. The flash photo-discharge curves of the Examples I, IV and III, VI show much less concentration dependence that the Comparative Examples I and II. Discharge is completed in <50 ms timescale with N,N′-bis(4-methylphenyl)-N,N′-bis[4-(n-butyl)phenyl]-[p-terphenyl]-4,4″-diamine having the sharpest flash discharge.

All the patents and applications referred to herein are hereby specifically, and totally incorporated herein by reference in their entirety in the instant specification.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An imaging member comprising:
a substrate in a form of a rigid component, wherein said substrate possesses a thickness of from about 0.5 millimeter to about 10 millimeters micrometers;
an undercoat layer disposed on the substrate;
a charge generation layer disposed on the undercoat layer;
a charge transport layer disposed on the charge generation layer, the charge transport layer having a high mobility charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof; and
an optional overcoat layer disposed on the charge transport layer.

2. The imaging member of claim 1, wherein the substrate comprises a material selected from the group consisting of a metal, metal alloy, aluminum, zirconium, niobium, tantalum, vanadium, hafnium, titanium, nickel, stainless steel, chromium, tungsten, molybdenum, and mixtures thereof.

3. The imaging member of claim 1, wherein a thickness of the charge transport layer is from about 2 μm to about 65 μm.

4. The imaging member of claim 3, wherein a thickness of the charge transport layer is from about 5 μm to about 55 μm.

5. The imaging member of claim 1, wherein the charge transport layer comprises a polymeric binder having a viscosity-molecular weight of from about 20,000 to about 150,000.

6. The imaging member of claim 5, wherein the polymeric binder is a polycarbonate Z polymer.

7. The imaging member of claim 5, further comprises polytetrafluoroethylene particles uniformly dispersed throughout the polymeric binder

8. The imaging member of claim 1, wherein the undercoat layer comprises a compound selected from the group consisting of phenolic resin, phenolic compound, metal oxide, silicon oxide, polyamides, hydroxy alkyl methacrylates, nylons, gelatin, hydroxyl alkyl cellulose, organopolyphosphazines, organosilanes, organotitanates, organozirconates, nitrogen-containing siloxanes, and mixtures thereof.

9. The imaging member of claim 1, wherein the undercoat layer has a thickness of from about 0.2 μm to about 25 μm.

10. The imaging member of claim 1, wherein the charge generation layer comprises a material selected from the group consisting of inorganic photoconductive materials, amorphous selenium, trigonal selenium, selenium alloys, selenium-tellurium, selenium-tellurium-arsenic, selenium arsenide, organic photoconductive materials, phthalocyanine pigments, X-form of metal free phthalocyanine, metal phthalocyanines, vanadyl phthalocyanine, copper phthalocyanine, quinacridones, dibromo anthanthrone pigments, benzimidazole perylene, substituted 2,4-diamino-triazines, polynuclear aromatic quinones, enzimidazole perylene, and mixtures thereof.

11. The imaging member of claim 1, wherein the charge generation layer has a thickness of from about 0.01 μm to about 5 μm.

12. The imaging member of claim 1, wherein the terphenyl compound is present in the charge transport layer in an amount of about 25 percent to about 40 percent by weight of total weight of the charge transport layer.

13. The imaging member of claim 1, wherein the overcoat layer has a thickness of from about 0.1 μm to about 10 μm.

14. An imaging member comprising:
a substrate in a form of a rigid component, wherein said substrate possesses a thickness of from about 0.5 millimeter to about 10 millimeters;
an undercoat layer disposed on the substrate;
a charge transport layer disposed on the undercoat layer, the charge transport layer having a high mobility charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof;
a charge generation layer disposed on the charge transport layer; and
an optional overcoat layer disposed on the charge generation layer.

15. The imaging member of claim 14, wherein the terphenyl compound is present in the charge transport layer in an amount of about 25 percent to about 50 percent by weight of total weight of the charge transport layer.

16. An imaging member comprising:
a substrate in a form of a rigid component, wherein said substrate possesses a thickness of from about 500 micrometers to about 3,000 micrometers;
an undercoat layer disposed on the substrate;
a charge generation layer disposed on the undercoat layer; and
a charge transport layer disposed on the charge generation layer, the charge transport layer further comprising
a charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1′-biphenyl-4,4′-diamine, and mixtures thereof, and
a polymeric binder comprising poly(4,4′-dihydroxy-diphenyl-1,1-cyclohexane.

17. An image forming apparatus for forming images on a recording medium comprising:
a) an imaging member having a charge retentive-surface for receiving an electrostatic latent image thereon, wherein the imaging member comprises
a substrate in a form of a rigid component, wherein said substrate possesses a thickness of from about 0.5 millimeter to about 10 millimeters,
an undercoat layer disposed on the substrate,
a charge generation layer disposed on the undercoat layer,
a charge transport layer disposed on the charge generation layer, the charge transport layer having a charge transport molecule comprising a terphenyl compound selected from the group consisting of N,N′-bis(4-methylphenyl)-N,N′-bis[4-(n-butyl)phenyl]-[p-terphenyl]-4,4″-diamine, N,N′-bis(3-methylphenyl)-N,N′-bis[4-(n-butyl)phenyl]-[p-terphenyl]-4,4″-diamine, N,N′-bis(4-tert-butylphenyl)-N,N′-bis[4-(n-butyl)phenyl]-[p-terphenyl]-4,4″-diamine, N,N′-bis(3,4-dimethylphenyl)-N,N′-bis[4-(n-butyl)phenyl]-[p-terphenyl]-4,4″-diamine, N,N,N′,N′-tetra-p-tolyl-1,1 ′-biphenyl-4,4′-diamine, and mixtures thereof, and
an optional overcoat layer disposed on the charge transport layer;
b) a development component for applying a developer material to the charge-retentive surface to develop the electrostatic latent image to form a developed image on the charge-retentive surface;
c) a transfer component for transferring the developed image from the charge-retentive surface to a copy substrate; and
d) a fusing component for fusing the developed image to the copy substrate.

18. The image forming apparatus of claim 17, wherein the substrate comprises a material selected from the group consisting of a metal, metal alloy, aluminum, zirconium, niobium, tantalum, vanadium, hafnium, titanium, nickel, stainless steel, chromium, tungsten, molybdenum, and mixtures thereof.

19. The image forming apparatus of claim 17, wherein a thickness of the charge transport layer is from about 2 μm to about 65 μm.

20. The image forming apparatus of claim 17, wherein the charge transport layer comprises a polymeric binder having a viscosity-molecular weight of from about 20,000 to about 150,000.

21. The image forming apparatus of claim 20, further comprises polytetrafluoroethylene particles uniformly dispersed throughout the polymeric binder.

22. The image forming apparatus of claim 17, wherein the terphenyl compound is present in the charge transport layer in an amount of about 25 percent to about 50 percent by weight of total weight of the charge transport layer.
